(19) United States
(12) Patent Application Publication
(10) Pub. No.: US 2026/0291697 A1
(43) Pub. Date: Sep. 24, 2026

(54) METHOD FOR RECEIVING DOWNLINK CHANNEL, USER EQUIPMENT AND STORAGE MEDIUM, AND METHOD FOR TRANSMITTING DOWNLINK CHANNEL, AND BASE STATION

(71) Applicant: HYUNDAI MOBIS CO., LTD., Seoul (KR)

(72) Inventor: TAE HYOUNG KIM, Cheonan-si Chungcheongnam-do (KR)

(73) Assignee: HYUNDAI MOBIS CO., LTD., Seoul (KR)

(21) Appl. No.: 19/473,400

(22) PCT Filed: Apr. 25, 2024
(86) PCT No.: PCT/KR2024/095765

§ 371 Date: Oct. 7, 2025

(30) Foreign Application Priority Data
Apr. 27, 2023 (JP) 10-2023-0055717

(51) Int. Cl. H04L 5/00; H04W 72/232

(52) U.S. Cl. CPC H04L 5/0094; H04L 5/0007; H04L 5/0053; H04W 72/232

(57) ABSTRACT

In some embodiments of the present specification, a CORESET comprises: one or more RB sets each including a plurality of consecutive RBs in a frequency domain; and one or more OFDM symbols in a time domain, wherein: a PDCCH has one or more CCEs in the CORESET; and each CCE in the CORESET can be defined to be the same as one interlace during an OFDM symbol in an RB set for the CORESET.

### TECHNICAL FIELD

The present specification relates to a wireless communication system.

### BACKGROUND

Various devices and technologies, such as machine-to-machine (M2M) communication, machine-type communication (MTC), and a smartphone and a tablet PC that require high data transmission rates, are emerging and becoming widespread. Accordingly, the amount of data required to be processed on cellular networks is rapidly increasing. To meet this rapidly increasing data processing demand, technologies, such as carrier aggregation and cognitive radio, for efficiently using more frequency bands, a multi-antenna technology, a multi-base station (BS) cooperation technology, and the like for increasing data capacity transmitted within limited frequencies are being developed.

Wireless communication systems support communications between user equipment (UEs) using available system resources (e.g., bandwidth, transmission power, etc.). With the introduction of new wireless communication technologies, the number of UEs to which a BS needs to provide services within a predetermined resource area is increasing, and the amount of data and control information transmitted and received with the UEs served by the BS is also increasing. Since the amount of radio resources available to the BS for communication with the UE(s) is finite, new methods are required to enable the BS to efficiently receive and transmit uplink/downlink data and/or uplink/downlink control information from and to the UE or UEs using these limited radio resources. That is, as node density and/or UE density increase, methods for efficiently using high-density nodes or high-density UEs for communication are required.

In consideration of the rapidly increasing volume of communications, methods that uses an unlicensed spectrum, that is, a shared spectrum, not licensed to a specific network operator but freely available for use by multiple network operators have been discussed.

### DISCLOSURE

### Technical Problem

The operations in licensed spectrum, which may be licensed to a specific network operator and exclusively or preferentially used by the corresponding network operator are difficult to apply to a shared spectrum, which is a unlicensed spectrum freely available for use by multiple network operators. In consideration of the unique characteristics of a shared spectrum, or the possibility that operations designed for the shared spectrum may be applied to unshared spectrum, it is necessary to define wireless communication technologies that are suitable for, or take into account, the operation of the shared spectrum.

Objects of the present specification are not limited to the above object, and other objects that are not described will be able to be clearly understood by those skilled in the art to which the present specification pertains based on the following description.

### Technical Solution

According to an aspect of the present specification, there is provided a method for transmitting, by a user equipment, a downlink channel in a wireless communication system. The method includes receiving a configuration for a control resource set (CORESET), monitoring a set of physical downlink control channel (PDCCH) candidates based on the configuration, and detecting a downlink control information (DCI) format within the set of PDCCH candidates. The CORESET consists of N^{CORESET}_{RB-set} resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

According to another aspect of the present specification, there is provided a user equipment for receiving a downlink channel in a wireless communication system. The user equipment includes at least one transceiver, at least one processor, and at least one memory that is operatively connected to the at least one processor and stores instructions that, when executed, cause the at least one processor to perform operations. The operations include receiving a configuration for a control resource set (CORESET), monitoring a set of physical downlink control channel (PDCCH) candidates based on the configuration, and detecting a downlink control information (DCI) format within the set of PDCCH candidates. The CORESET consists of N^{CORESET}_{RB-set} resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

According to still another aspect of the present specification, there is provided a processing device. The processing device includes at least one processor, and at least one memory that is operatively connected to the at least one processor and stores instructions that, when executed, cause the at least one processor to perform operations. The operations include receiving a configuration for a control resource set (CORESET), monitoring a set of physical downlink control channel (PDCCH) candidates based on the configuration, and detecting a downlink control information (DCI) format within the set of PDCCH candidates. The CORESET consists of N^{CORESET}_{RB-set} resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

According to yet another aspect of the present specification, a computer-readable non-transitory storage medium including at least one computer program that causes at least one processor to perform operations. The operations include receiving a configuration for a control resource set (CORESET), monitoring a set of physical downlink control channel (PDCCH) candidates based on the configuration, and detecting a downlink control information (DCI) format within the set of PDCCH candidates. The CORESET consists of NCORESETRB-set resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

According to yet aspect of the present specification, there is provided a method of transmitting, by a base station, a downlink channel in a wireless communication system. The method includes transmitting a configuration for a control resource set (CORESET), and based on the configuration, transmitting a downlink control information (DCI) format within a set of physical downlink control channel (PDCCH) candidates. The CORESET consists of N^{CORESET}_{RB-set} resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

According to yet aspect of the present specification, there is provided a base station for transmitting a downlink channel in a wireless communication system. The base station includes at least one transceiver, at least one processor, and at least one memory that is operatively connected to the at least one processor and stores instructions that, when executed, cause the at least one processor to perform operations. The operations include transmitting a configuration for a control resource set (CORESET), and based on the configuration, transmitting a downlink control information (DCI) format within a set of physical downlink control channel (PDCCH) candidates. The CORESET consists of N^{CORESET}_{RB-set} resource blocks (RBs), each of which includes a plurality of contiguous RBs in a frequency domain, and NCORESETsymb orthogonal frequency division multiplexing (OFDM) symbols in a time domain, each PDCCH candidate within the CORESET consists of one or more control channel elements (CCEs), and each CCE within the CORESET is equal to one interlace during an OFDM symbol within an RB set for the CORESET.

In each aspect of the present specification, each of the one or more interlaces may consist of a plurality of non-contiguous RBs.

In each aspect of the present specification, the CCEs within the CORESET may be numbered in increasing order in a frequency-first manner, starting from 0 for the first OFDM symbol and the lowest-numbered interlace within the CORESET.

In each aspect of the present specification, the CCEs within the CORESET may be numbered in increasing order in a time-first manner, starting from 0 for the first OFDM symbol and the lowest-numbered interlace within the CORESET.

In each aspect of the present specification, the configuration may include the number of PDCCH candidates for each aggregation level (L). Each PDCCH candidate at the aggregation level L may include L CCEs within the COREST.

In each aspect of the present specification, each PDCCH candidate within the CORESET may consist of CCEs from one RB set.

In each aspect of the present specification, each PDCCH candidate within the CORESET may consist of CCEs from a plurality of RB sets.

In each aspect of the present specification, two adjacent RB sets among the N^{CORESET}_{RB-set} RB sets within the CORESET may have a guard band between the two adjacent RB sets.

In each aspect of the present specification, each CCE within the CORESET may not be mapped to an interlace in which some RBs are included in the guard band.

In each aspect of the present specification, the CORESET may include a CCE mapped to an interlace in which some RBs are included in the guard band.

The above configurations are merely some examples of the present specification, and various examples reflecting the technical features of the present specification can be derived and understood by those skilled in the art based on the following detailed description.

### Advantageous Effects

According to some implementations of the present specification, wireless communication signals can be efficiently transmitted and received. Accordingly, the overall throughput of the wireless communication system can be increased.

According to some implementations of the present specification, wireless communications can be performed efficiently in the shared spectrum, which is an unlicensed spectrum that is not licensed to a specific network operator and freely available for use by multiple network operators.

According to some implementations of the present specification, radio resources on the shared spectrum can be used more efficiently.

According to some implementations of the present specification, the transmission/reception performance of the physical downlink control channel can be improved for operations involving the shared spectrum channel access process.

According to some implementations of the present specification, the transmission/reception performance of the physical downlink control channel can be improved in cells or frequency bands to which interlace-based transmission is applied.

Effects of the present specification are not limited to the above object, and other effects that are not described will be able to be clearly understood by those skilled in the art to which the present specification pertains based on the following description.

### BRIEF DESCRIPTION OF THE DRAWINGS

FIG. 1 illustrates an example of a communication system (1) to which implementations of the present specification may be applied.

FIG. 2 is a block diagram illustrating examples of communication devices capable of performing a method according to the present specification.

FIG. 3 illustrates an example of a frame structure available in a 3rd Generation Partnership Project (3GPP)-based wireless communication system.

FIG. 4 illustrates a resource grid of a slot.

FIG. 5 illustrates an example of a physical downlink control channel (PDCCH) structure used in a 3GPP-based wireless communication system.

FIG. 6 illustrates mapping methods between control channel elements (CCEs) and resource element groups (REGs).

FIG. 7 illustrates a resource block (RB) interlace.

FIG. 8 illustrates interlaced RB-based uplink resource allocation in a shared spectrum.

FIGS. 9 and 10 illustrate the basic concept of an interlace-based PDCCH structure according to some implementations of the present specification.

FIG. 11 illustrates examples of interlace-to-CCE mapping for the interlace-based PDCCH according to some implementations of the present specification.

FIGS. 12 and 13 illustrate examples of CCE aggregation according to some implementations of the present specification.

FIGS. 14 to 18 illustrate examples of transmitting a PDCCH across multiple RB sets according to some implementations of the present specification.

FIG. 19 illustrates a portion of a process by which a user equipment receives a downlink channel according to some implementations of the present specification.

FIG. 20 illustrates a portion of a process by which a base station transmits a downlink channel according to some implementations of the present specification.

FIG. 21 illustrates a PDCCH transmission/monitoring flow according to some implementations of the present specification.

### DETAILED DESCRIPTION

Hereinafter, various implementations of the present specification will be described in detail with reference to the accompanying drawings. The detailed description set forth below together with the accompanying drawings is intended to illustrate exemplary implementations of the present specification and is not intended to represent the only possible implementations of the present specification. The following detailed description includes specific details to provide a thorough understanding of the present specification. However, those skilled in the art will understand that the present specification may be carried out without these specific details.

In some cases, well-known structures and devices may be omitted or illustrated in the form of a block diagram, focusing on core functions of each structure and device, to avoid obscuring the concepts of the present specification. In addition, the same reference numerals will be used throughout the present specification to describe the same components.

The techniques, devices, and systems, which will be described below, may be applied to various wireless multiple access systems.

For convenience of description, hereinafter, the present specification will be described based on a 3rd Generation Partnership Project (3GPP)-based communication system. However, the technical features of the present specification are not limited thereto. For example, although the following detailed description is based on 3GPP LTE or 5G technology, some implementations of the present specification are also applicable to any other mobile communication system and systems to be introduced in the future (e.g., 6G) except for matters specific to 3GPP LTE/5G.

Among terms and technologies used in the present specification, terms and technologies that are not specifically described may reference 3GPP-based standard documents, for example, 3GPP TS 23.304, 3GPP TS 23.285, 3GPP TS 23.287, 3GPP TS 24.587, 3GPP TS 36.211, 3GPP TS 36.212, 3GPP TS 36.213, 3GPP TS 36.300, 3GPP TS 36.321, 3GPP 36.322, 3GPP TS 36.323, 3GPP TS and 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.321, 3GPP TS 38.322, 3GPP TS 38.323, 3GPP TS 38.331, etc.

In the examples of the present specification, which will be described below, the expression that a device “assumes” may mean that an entity transmitting a channel transmits the channel according to the “assumption.” This may mean that an entity receiving the channel receives or decodes the channel according to the “assumption” under the premise that the channel was transmitted according to the “assumption.”

In the present specification, user equipment (UE) may be fixed or may have mobility and includes various devices that communicate with a base station (BS) to transmit and/or receive user data and/or various control information. The UE may be referred to as terminal equipment, a mobile station (MS), a mobile terminal (MT), or a user terminal (UT). In addition, in the present specification, the BS generally refers to a fixed station that communicates with a UE and/or other BSs and exchanges various data and control information with the UE and other BSs. The BS may be referred to by other terms, such as an advanced BS (ABS), a node-B (NB), an evolved node-B (eNB), a gNB, a base transceiver system (BTS), an access point (AP), a processing server (PS), etc. Hereinafter, for convenience of description, a base station is referred to as a BS regardless of the type or version of the communication technology.

In the present specification, a node refers to a fixed point capable of transmitting and receiving radio signals in communication with a UE. Various types of BSs, regardless of their names, may be used as nodes. At least one antenna is installed on one node. The antenna may refer to a physical antenna, an antenna port, a virtual antenna, or an antenna group. A node is also referred to as a point.

Meanwhile, 3GPP-based communication systems use the concept of cells to manage radio resources, and the cell associated with radio resources is distinguished from a cell within a geographic area. The “cell” within the geographic area can be understood as a coverage area in which a node may provide services using a carrier, and the “cell” of the radio resource is associated with a bandwidth (BW), which is a frequency range configured by the carrier. Since downlink coverage, which is a range in which a node may transmit valid signals, and uplink coverage, which is a range in which a node may at least partially depend on the carrier carrying the corresponding signals, the coverage of the node is associated with the coverage of the “cell” of the radio resources used by the node. Accordingly, the term “cell” may be used to sometimes refer to the coverage of the service by the node, sometimes to the radio resource, and sometimes to the range in which the signal using the radio resource may reach with valid strength.

The “cell” associated with the radio resource may be defined as a combination of downlink (DL) resources and uplink (UL) resources, that is, a DL component carrier (CC) and an UL CC. The cell may be configured with the DL resource only or with a combination of the DL and UL resources. When carrier aggregation is supported, linkage between a carrier frequency of the DL resources (or DL CCs) and a carrier frequency of the UL resources (or UL CCs) may be indicated by system information. Here, the carrier frequency may be the same as or different from a center frequency of each cell or CC according to the system setting.

In a wireless communication system, a UE receives information from the BS via the DL, and the UE transmits information to the BS via the UL. The information transmitted and/or received by the BS and the UE includes data and various control information, and various physical channels are present depending on the type and purpose of the information transmitted and/or received by the channels.

3GPP-based communication standards define downlink physical channels corresponding to resource elements carrying information originating from higher-level layers, and downlink physical signals corresponding to resource elements used by the physical layer but not carrying information originating from higher-level layers. For example, a physical downlink shared channel (PDSCH), a physical broadcast channel (PBCH), a physical downlink control channel (PDCCH), and the like are defined as downlink physical channels, and reference signals and synchronization signals are defined as downlink physical signals. A reference signal (RS), which is referred to as a pilot, refers to a signal with a predefined, specific waveform known to both the BS and the UE. For example, a demodulation reference signal (DMRS), a channel state information RS (CSI-RS), and the like are defined as downlink reference signals. 3GPP-based communication standards define upperlink physical channels corresponding to resource elements carrying information originating from higher-level layers, and upperlink physical signals corresponding to resource elements used by the physical layer but not carrying information originating from higher-level layers. For example, a physical uplink shared channel (PUSCH), a physical uplink control channel (PUCCH), and a physical random access channel (PRACH) are defined as uplink physical channels and define the demodulation reference signal (DMRS) for uplink control/data signals, a sounding reference signal (SRS) used for uplink channel measurement, etc.

In the present specification, the PDCCH refers to a set of time-frequency resources (e.g., resource elements (REs)) carrying downlink control information (DCI), and the PDSCH refers to a set of time-frequency resources carrying downlink data. In addition, the PUCCH, the PUSCH, and the PRACH refer to sets of time-frequency resources carrying uplink control information (UCI), uplink data, and a random access preamble, respectively. Hereinafter, the expression that a UE/BS transmits/receives a PUCCH/PUSCH/PRACH is used with the same meaning as transmitting/receiving UCI/uplink data/random access preamble on or via the PUCCH/PUSCH/PRACH, respectively. In addition, the expression that a BS/UE transmits/receives a PBCH/PDCCH/PDSCH is used with the same meaning as transmitting/receiving broadcast information/DCI/downlink data on or via the PBCH/PDCCH/PDSCH, respectively.

In the present specification, radio resources (e.g., time-frequency resources) scheduled or configured by the BS to the UE for transmission or reception of the PUCCH/PUSCH/PDSCH are also referred to as PUCCH/PUSCH/PDSCH resources.

Since a communication device receives physical channels and/or physical signals in the form of radio signals, it is not possible to selectively receive, via a radio frequency (RF) receiver, only those radio signals that include a specific physical channel or a specific physical signal, or to selectively receive, via the RF receiver, only those radio signals that exclude a specific physical channel or a specific physical signal. In actual operation, the communication device first receives the radio signals on the cell via the RF receiver, converts the received radio signals, which are RF band signals, into baseband signals, and decodes the physical signals and/or physical channels within the baseband signals using one or more processors. Accordingly, in some implementations of the present specification, when the physical signal and/or the physical channel are not received, it does not actually mean that the communication device does not receive radio signals including the physical signal and/or the physical channel at all, but rather does not attempt to recover the physical signal and/or the physical channel, for example, does not attempt to decode the physical signal and/or the physical channel from the radio signals.

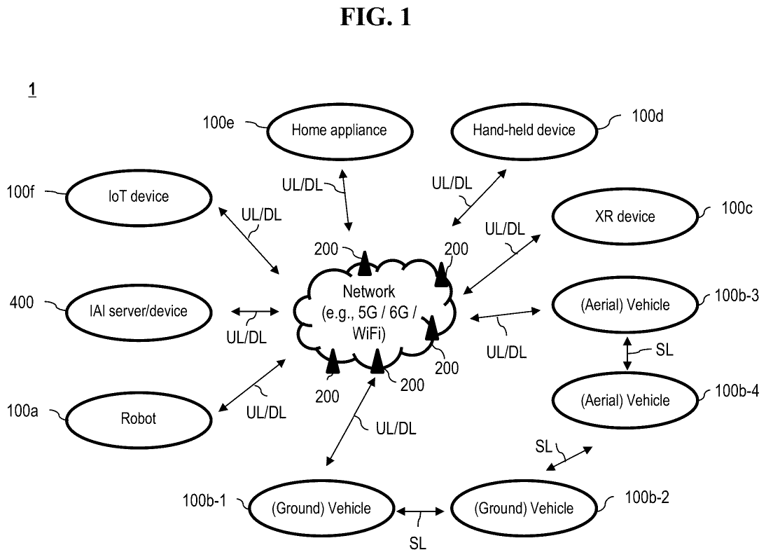

FIG. 1 illustrates an example of a communication system 1 to which implementations of the present specification may be applied.

Referring to FIG. 1, the communication system 1 applied to the present specification includes a wireless device, a base station (BS), and a network. Here, the wireless device may refer to a device that performs communication using wireless access technology (e.g., 5G NR (New RAT), LTE (e.g., E-UTRA), Wi-Fi, and 6G to be introduced in the future).

Although not limited thereto, the wireless device may include a robot 100a, vehicles 100b-1, 100b-2, 100b-3, an 100b-4, an extended Reality (XR) device 100c, a hand-held device 100d, a home appliance 100e, an Internet of Things (IoT) device 100f, and an artificial intelligence (AI) device/server 400. For example, the vehicle may include a ground vehicle having wireless communication capability, an autonomous vehicle, a vehicle capable of communicating between vehicles, etc. Here, the vehicle may include an unmanned aerial vehicle (UAV) (e.g., a drone) and an urban air mobility (UAM) (e.g., an unmanned aerial traffic). The XR device may include augmented reality (AR)/virtual reality (VR)/mixed reality (MR) devices. The mobile device may include a smartphone, a smartpad, a wearable device (e.g., a smartwatch, smart glasses), a computer (e.g., a laptop), etc. The home appliance may include a TV, a refrigerator, a washing machine, etc. The IoT device may include a sensor, a smart meter, etc. For example, the BS and the network may also be implemented as wireless devices, and a specific wireless device may operate as a BS/network node for other wireless devices.

The wireless devices 100a to 100f may be connected to the network via the BS 200. The wireless devices 100a to 100f may adopt AI technology and may be connected to the AI server 400 via a network. The wireless devices 100a to 100f may communicate with each other via the BS 200/network, but may directly communicate with each other (e.g., sidelink communication) without the BS/network. For example, the vehicles 100b-1, 100b-2, 100b-3, and 100b-4 may directly communicate with each other (e.g., vehicle to vehicle (V2V)/vehicle to everything (V2X) communication). In addition, the IoT device (e.g., a sensor) may communicate directly with other IoT devices (e.g., a sensor) or other wireless devices 100a to 100f.

Wireless communication/connection may be established between the wireless devices 100a to 100f/BS 200 and the BS 200/wireless devices 100a to 100f. Here, wireless communication/connection may be established through various wireless access technologies (e.g., 5G NR) for uplink/downlink (UL/DL) communication and sidelink (SL) communication (or D2D communication). Through wireless communication/connection (UL/DL, SL), the wireless device and the BS/the wireless device may transmit/receive radio signals. To this end, at least some of various configuration information configuration processes, various signal processing processes (e.g., channel encoding/decoding, modulation/demodulation, resource mapping/demapping, and the like), a resource allocation process, and the like for transmitting/receiving radio signals may be performed based on various proposals of the present specification.

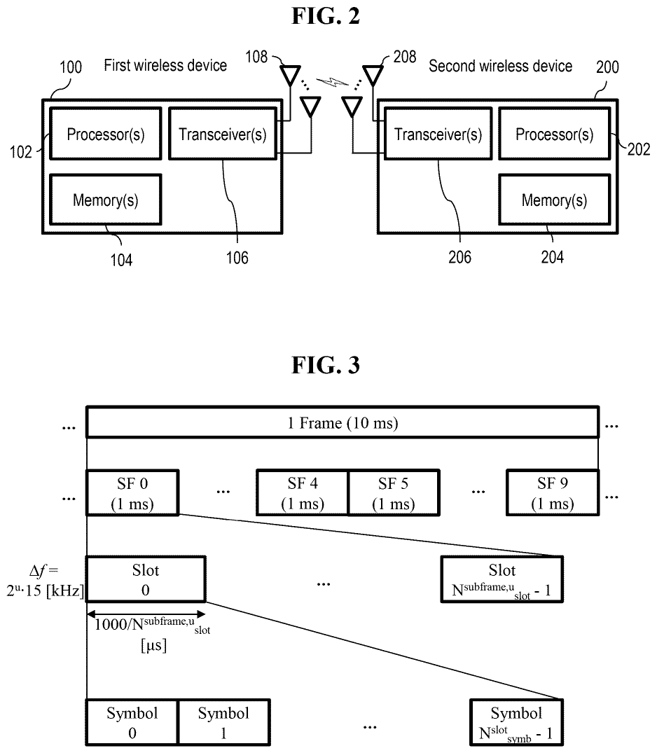

FIG. 2 is a block diagram illustrating examples of communication devices capable of performing a method according to the present specification. Referring to FIG. 2, a first wireless device 100 and a second wireless device 200 may transmit and/or receive radio signals using various wireless access technologies. Here, the first wireless device 100 and the second wireless device 200 may correspond one-to-one to the wireless device 100x and the BS 200 and/or the wireless device 100x and the wireless device 100x of FIG. 1.

Each of the first wireless device 100 and the second wireless device 200 includes one or more processors 102 and 202 and one or more memories 104 and 204 and further include one or more transceivers 106 and 206 and/or one or more antennas 108. The processors 102 and 202 may be configured to control the memories 104 and 204 and/or the transceivers 106 and 206 and implement functions, procedures, and/or methods, which will be described/suggested below. For example, the processors 102 and 202 may process information in the memories 104 and 204 to generate first information/signal and transmit a radio signal including the first information/signal via the transceivers 106 and 206. In addition, the processors 102 and 202 may receive a radio signal including second information/signal via the transceivers 106 and 206 and store information obtained by processing the second information/signal in the memories 104 and 204. The memories 104 and 204 may be connected to the processors 102 and 202 and may store various information related to the operations of the processors 102 and 202. For example, the memories 104 and 204 may perform some or all of processes controlled by the processors 102 and 202 or store software code including commands for performing the procedures and/or methods, which will be described/proposed below. Here, the processors 102 and 202 and the memories 104 and 204 may be portions of a communication modem/circuit/chip designed to implement wireless communication technology. The transceivers 106 and 206 may be connected to the processors 102 and 202 and may transmit and/or receive radio signals via one or more antennas 108 and 208. The transceivers 106 and 206 may include a transmitter and/or a receiver.

Although not limited thereto, one or more protocol layers may be implemented by the one or more processors 102 and 202. For example, the one or more processors 102 and 202 may implement one or more layers (e.g., functional layers such as a physical (PHY) layer, a medium access control (MAC) layer, a radio link control (RLC) layer, a packet data convergence protocol (PDCP) layer, a radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present specification. The one or more processors 102 and 202 may generate messages, control information, data, or information according to the functions, procedures, proposals, and/or methods disclosed in the present specification. The one or more processors 102 and 202 may generate signals (e.g., baseband signals) containing PDUs, SDUs, messages, control information, data, or information according to the functions, procedures, proposals, and/or methods disclosed in the present specification and provide the signals to the one or more transceivers 106 and 206. The one or more processors 102 and 202 may receive signals (e.g., baseband signals) from the one or more transceivers 106 and 206 and acquire PDUs, SDUs, messages, control information, data, or information according to the functions, procedures, proposals, and/or methods disclosed in the present document.

The one or more processors 102 and 202 may be referred to as a controller, a microcontroller, a microprocessor, or a microcomputer. The one or more processors 102 and 202 may be implemented by hardware, firmware, software, or a combination thereof, and the firmware or software may be implemented to include modules, procedures, functions, etc. Firmware or software configured to perform the functions, procedures, proposals, and/or methods disclosed in the present specification may be included in the one or more processors 102 and 202 or stored in the one or more memories 104 and 204 and executed by the one or more processors 102 and 202. The functions, procedures, suggestions, and/or methods disclosed in the present specification may be implemented using firmware or software in the form of code, instructions, and/or sets of instructions.

The one or more memories 104 and 204 may be coupled to the one or more processors 102 and 202 and may store various forms of data, signals, messages, information, programs, codes, instructions, and/or commands. The one or more memories 104 and 204 may be located inside and/or outside the one or more processors 102 and 202. In addition, the one or more memories 104 and 204 may be connected to the one or more processors 102 and 202 using various technologies, such as wired or wireless connections.

The one or more transceivers 106 and 206 may transmit/receive user data, control information, wireless signals/channels, and the like, as described in the methods and/or operational flowcharts of the present specification, to/from one or more other devices. In addition, the one or more processors 102 and 202 may control the one or more transceivers 106 and 206 to transmit/receive user data, control information, or wireless signals to/from one or more other devices. In addition, the one or more transceivers 106 and 206 may be connected to the one or more antennas 108 and 208, and the one or more transceivers 106 and 206 may be configured to transmit and/or receive user data, control information, wireless signals/channels, and the like, as described in the functions, procedures, proposals, methods, and/or operational flowcharts disclosed in the present specification, via the one or more antennas 108 and 208. In the present specification, the one or more antennas may be a plurality of physical antennas or a plurality of logical antennas (e.g., antenna ports). The one or more transceivers 106 and 206 may convert received user data, control information, wireless signals/channels, and the like from RF band signals into baseband signals to process the received user data, control information, wireless signals/channels, and the like using the one or more processors 102 and 202. The one or more transceivers 106 and 206 may convert user data, control information, wireless signals/channels, and the like processed using the one or more processors 102 and 202 from baseband signals to RF band signals. To this end, the one or more transceivers 106 and 206 may include an (analog) oscillator and/or a filter.

In the present specification, the one or more memories 104 and 204 may store instructions or programs, and during execution, the instructions or programs may cause the one or more processors 102 and 202 operably connected to the one or more memories to perform operations according to some embodiments or implementations of the present specification.

In the present specification, a computer-readable (non-transitory) storage medium may store one or more instructions or computer programs, and when executed by the one or more processors, the one or more instructions or computer programs may cause the one or more processors to perform the operations according to some embodiments or implementations of the present specification.

FIG. 3 illustrates an example of a frame structure available in a 3GPP-based wireless communication system.

The frame structure of FIG. 3 is merely an example, and the number of subframes, the number of slots, and the number of symbols in the frame may be diverse. In some wireless communication systems, an orthogonal frequency division multiplexing (OFDM) numerology (e.g., subcarrier spacing (SCS)) may be set differently between a plurality of cells aggregated to one UE. Accordingly, an (absolute time) duration of a time resource configured with the same number of symbols (e.g., a subframe, a slot, or a transmission time interval (TTI)) may be set differently among aggregated cells. Here, the symbol may include an OFDM symbol (or a cyclic prefix-OFDM (CP-OFDM) symbol) and an SC-FDMA symbol (or a discrete Fourier transform-spread-OFDM (DFT-s-OFDM) symbol). In the present specification, the symbol, the OFDM-based symbol, the OFDM symbol, the CP-OFDM symbol, and the DFT-s-OFDM symbol may be interchangeable.

Referring to FIG. 3, uplink and downlink transmissions are organized in units of frames. Each frame has a duration of Tr=(Δfₘₐₓ*N_{f}/100)*T_{c}=10 ms, where T_{c} (basic time unit)=1/(Δfₘₐₓ*N_{f}), Δfₘₐₓ=480*103 Hz, and N_{f}=4096. For reference, the sampling time Tₛ=1/(Δf_{ref}*N_{f,ref}), Δf_{ref}=15*103 Hz, and N_{f,ref}=2048 T_{c} and T_{f} have a relationship of K (constant)=Tₛ/T_{c}=64. A frame consists of 10 subframes, and a duration of a single subframe, T_{sf}, is 1 ms. The subframes are further divided into slots, and the number of slots in a subframe depends on the subcarrier spacing. Each slot may consist of N^{slot}_{symb} symbols based on a cyclic prefix (CP). For example, in some scenarios, each slot consists of 14 OFDM symbols in the case of a normal CP and 12 OFDM symbols in the case of an extended CP. The numerology depends on the exponentially scalable subcarrier spacing Δf-2^{u*}15 kHz. The following table shows the number of OFDM symbols per slot (N^{slot}_{symb}), the number of slots per frame (N^{frame,u}ₛₗₒₜ), and the number of slots per subframe (N^{subframe,u}ₛₗₒₜ) according to the subcarrier spacing Δf=2^{u*}15 kHz for the normal CP.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

The following table shows the number of OFDM symbols per slot, the number of slots per frame, and the number of slots per subframe according to the subcarrier spacing Δf=2^{u*}15 kHz for the extended CP.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

For a subcarrier spacing configuration u, slots are numbered in increasing order within a subframe as n^{u}ₛ={0, . . . , n^{subframe,u}ₛₗₒₜ−1} and in increasing order within a frame as nus,f={0, . . . , n^{frame,u}ₛₗₒₜ−1}.

Hereinafter, implementations of the present specification are described by referring to the minimum unit of time for scheduling uplink, downlink, and sidelink transmissions as a slot, but the minimum unit of time for scheduling may be referred to by different terms depending on the wireless communication system. For example, in an LTE-based system, the minimum unit of time for scheduling transmissions is referred to as a subframe or a transmission time interval (TTI), while, in an NR-based system, the minimum unit of time for scheduling is referred to as a slot.

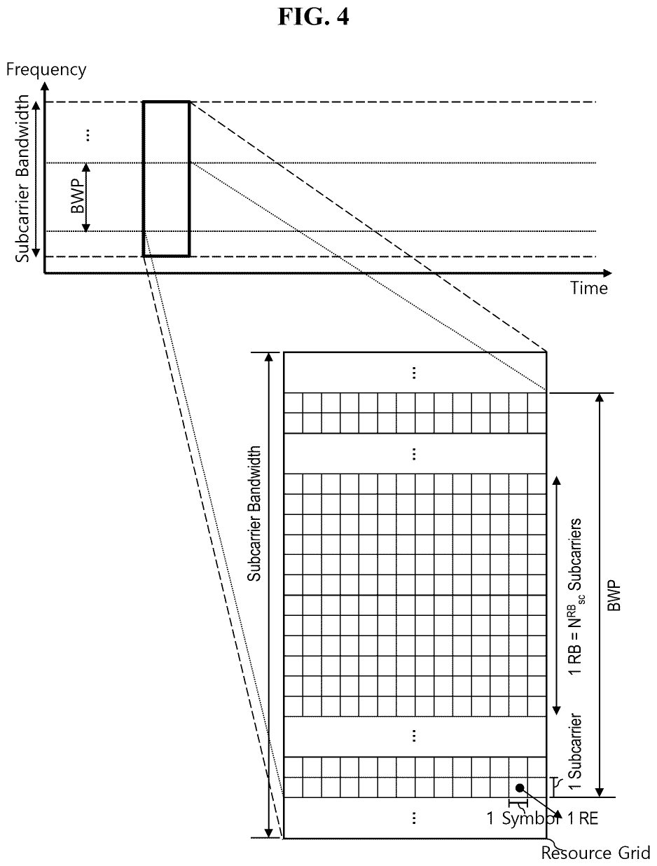

FIG. 4 illustrates a resource grid of a slot. A slot includes a plurality of symbols (e.g., N^{slot}_{symb}) in a time domain. For each numerology (e.g., a subcarrier spacing) and carrier, a resource grid of N^{size,u}_{grid,x}*N^{RB}_{sc} subcarriers and Nsubframe, usymmb OFDM symbols starting from a common resource block (CRB) N^{size,u}_{grid} indicated by higher-level layer signaling (e.g., radio resource control (RRC) signaling) is defined. Here, N^{size,u}_{grid,x} is the number of resource blocks (RBs) in the resource grid, and the subscript x is DL for downlink and UL for uplink. N^{RB}_{sc} is the number of subcarriers per RB, and N^{RB}_{sc} is typically 12 in 3GPP-based wireless communication systems. There is one resource grid for a given antenna port p, a subcarrier spacing configuration u, and a transmission direction (DL or UL). A carrier bandwidth N^{size,u}_{grid} for the subcarrier spacing configuration u is provided to the UE by a higher-level layer parameter (e.g., an RRC parameter) from the network. Each element in the resource grid for the antenna port p and the subcarrier spacing configuration u is referred to as a resource element (RE), and each RE may be mapped to one complex-valued symbol. Each RE within the resource grid is uniquely identified by an index k in the frequency domain and an index 1 indicating a symbol position with respect to a reference point in the time domain. The RBs may be classified into CRBs and physical resource blocks (PRBs). The CRBs are numbered upwards from 0 in the frequency domain for the subcarrier spacing configuration u. The center of subcarrier 0 of CRB 0 for the subcarrier spacing configuration u coincides with “Point A,” which is a common reference point for RB grids. The PRBs for the subcarrier spacing configuration u are defined within a bandwidth part (BWP) and are numbered from 0 to N^{size,u}_{BWP,i-1}, where i is the number of the bandwidth part. A relationship between the CRB n^{u}_{CRB} and the PRB n_{PRB} within bandwidth part i is as follows. n^{u}_{PRB}=n^{u}_{CRB}+N^{start,u}_{BWPi}, where N^{start,u}_{BWP,i} is a CRB in which the bandwidth part starts relative to CRB 0. A BWP includes a plurality of contiguous RBs in the frequency domain. For example, the BWP is a subset of contiguous CRBs defined for a given numerology uᵢ within BWP i on a given carrier. The carrier may include up to N (e.g., 5) BWPs. A UE may be configured to have one or more BWPs on a given component carrier. Data communication is performed through the activated BWPs, and only a preconfigured number (e.g., 1) of BWPs configured for the UE may be activated on the corresponding carrier.

For each BWP, the UE may receive at least one of the following parameters for a serving cell: i) a subcarrier spacing, ii) a CP, iii) assuming that N^{start}_{BWP}=275, CRB N^{start}_{BWP}-O_{carrier}+RBₛₜₐᵣₜ and the number of contiguous RBs N^{size}_{BWP}=L_{RB}, which are provided by an RRC parameter locationAndBandwidth indicating an offset RBₛₑₜ and a length L_{RB} as resource indicator values (RIVs), the number of contiguous RBs N^{size}_{BWP}=L_{RB}, and O_{carrier} provided by an RRC parameter offsetToCarrier for a subcarrier spacing; indexes within the DL BWPs or UL BWPs; and a set of BWP-common parameters and a set of BWP-dedicated parameters.

Virtual resource blocks (VRBs) are defined within a bandwidth part and are numbered from 0 to N^{size,u}_{BWP,i}−1, where i is the number of the bandwidth part. The UE may assume that the VRBs are mapped to PRBs according to the mapping method indicated to the UE (e.g., non-interleaved or interleaved mapping). When no mapping method is indicated, the UE assumes non-interleaved mapping. In non-interleaved VRB-to-PRB mapping, VRB n may be mapped to PRB n. In interleaved VRB-to-PRB mapping, VRBs may be mapped to PRBs in a distributed manner according to predefined rules.

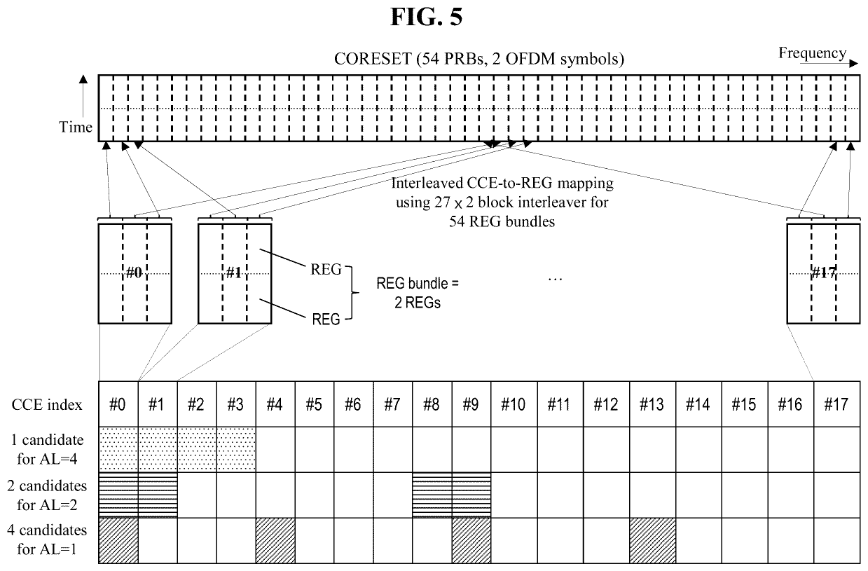

FIG. 5 illustrates an example of a PDCCH structure used in a 3GPP-based wireless communication system.

In 3GPP-based wireless communication systems, downlink control channel transmission is defined by a resource element group (REG) and/or a CCE.

In some scenarios (e.g., NR), a REG corresponds to one OFDM symbol in the time domain and one RB in the frequency domain. That is, the REG is the same as one RB during one OFDM symbol.

The CCE may refer to a minimum unit for control channel transmission. That is, the size of the minimum PDCCH may correspond to one CCE. According to an aggregation level AL L, a BS may aggregate L CCEs to transmit a single PDCCH. For example, in AL 4, a PDCCH consists of four CCEs.

The set of radio resources on which PDCCHs may be positioned is referred to as a control resource set (CORESET). The CORESET, which is a set of time-frequency resources over which a UE may monitor PDCCHs, may be defined and/or configured. One or more CORESETs may be configured for the UE. In some implementations, the CORESET consists of a set of physical resource blocks (PRBs) with a duration of 1, 2, or 3 OFDM symbols. The PRBs constituting the CORESET and the CORESET duration may be provided to the UE through higher-level layer (e.g., RRC) signaling. Within the configured CORESET(s), a set of PDCCH candidates is monitored according to the corresponding search space sets. In the present specification, monitoring implies decoding (referred to as “blind decoding”) each PDCCH candidate according to the monitored DCI formats. The following are examples of DCI formats that may be carried by the PDCCH.

TABLE 3

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |
| 2_4 | Notifying a group of UEs of PRB(s) and OFDM symbol(s) |
| | where UE cancels the corresponding UL transmission |
| | from the UE |

The set of PDCCH candidates monitored by the UE is defined in terms of PDCCH search space sets. The search space set may be a common search space (CSS) set or a UE-specific search space (USS) set. Each CORESET configuration is associated with one or more search space sets, and each search space set is associated with one CORESET configuration. For example, the search space set s may be determined based on the following parameters provided to the UE by the BS.
controlResourceSetId: an identifier identifying a CORESET p associated with a search space set s,
monitoringSlotPeriodicityAndOffset: a PDCCH monitoring periodicity of kₛ slots and a PDCCH monitoring offset of oₛ slots for configuring slots for PDCCH monitoring,
duration: a duration of Tₛ<kₛ slots, which indicate the number of slots in which a search space set s is present,
monitoringSymbolsWithinSlot: a PDCCH monitoring pattern within the slot, which indicates first symbol(s) of the CORESET within the slot for PDCCH monitoring,
nrofCandidates: the number of PDCCH candidates per CCE aggregation level, and
searchSpaceType: indicates whether the search space set s is a CSS set or a USS set.

The parameter monitoringSymbolsWithinSlot indicates, for example, the first symbol(s) for PDCCH monitoring within the slots configured for PDCCH monitoring (e.g., see parameters monitoringSlotPeriodicityAndOffset and duration). For example, when monitoringSymbolsWithinSlot is 14 bits, the most significant (left) bit represents a first OFDM symbol in the slot, the second most significant (left) bit represents a second OFDM symbol in the slot so that bits in monitoringSymbolsWithinSlot may represent 14 OFDM symbols in the slot, respectively. For example, the bit(s) configured as 1 among the bits in monitoringSymbolsWithinSlot identify the first symbol(s) of the CORESET in the slot.

In some scenarios, for a search space set s associated with a CORSET p, the CCE indices for the aggregation level L corresponding to a PDCCH candidate m_{s,n_CI} of a search space set in a slot n^{u}_{s,f} for a serving cell corresponding to a carrier aggregation field value n_CI may be given as follows.

$$L \cdot \{ ( {Y}_{p , {n}_{s , f}^{u}} + ⌊ \frac{{m}_{s , n \_ CI}^{( L )} \cdot {N}_{CCE , p}}{L \cdot {M}_{s , m ax}^{( L )}} ⌋ + n \_ CI ) mod ⌊ {N}_{CCE , p} / L ⌋ + i \} \qquad [ Equation 1 ]$$

where for any CSS,

$${Y}_{p , {n}_{s , f}^{u}} = 0 ;$$

### for USS,

$${Y}_{p , {n}_{s , f}^{u}} = ( {A}_{p} \cdot {Y}_{p , {n}_{s , f}^{u} - 1} ) mod D ,$$

Y_{p,-1}=n_{RNTI}≠0 (where an RNTI value used for nRNTI is a cell radio network temporary identifier (C-RNTI)), for p mod 3-0, Aₚ=39827, for p mod 3=1, Aₚ=39829, for p mod 3=2, Aₚ=39839, and D=65537; i=0, . . . , L−1; N_{CCE,p} is the number of CCEs within CORESET p and, if any, per RB set, numbered from 0 to N_{CCE,p}−1; n_CI is a carrier indicator field value when it is set by cross-carrier scheduling configuration for the PDCCH monitored serving cell, except for the case of scheduling of the serving cell from the same serving cell (in which case, n_CI=0); m^{(L)}_{s,n_CI}=0, . . . , M^{(L)}_{s,nCI}−1, where M^{(L)}_{s,n_CI} is the number of PDCCH candidates configured to monitor for the serving cell corresponding to n_CI for the aggregation level L of the search space set s; for any CSS, M^{(L)}_{s,max}=M^{(L)}_{s,o}; for USS, M^{(L)}_{s,max} is the maximum of M^{(L)}_{s,n_CI} for all configured n_CI values for the CCE aggregation level L of the search space set s.

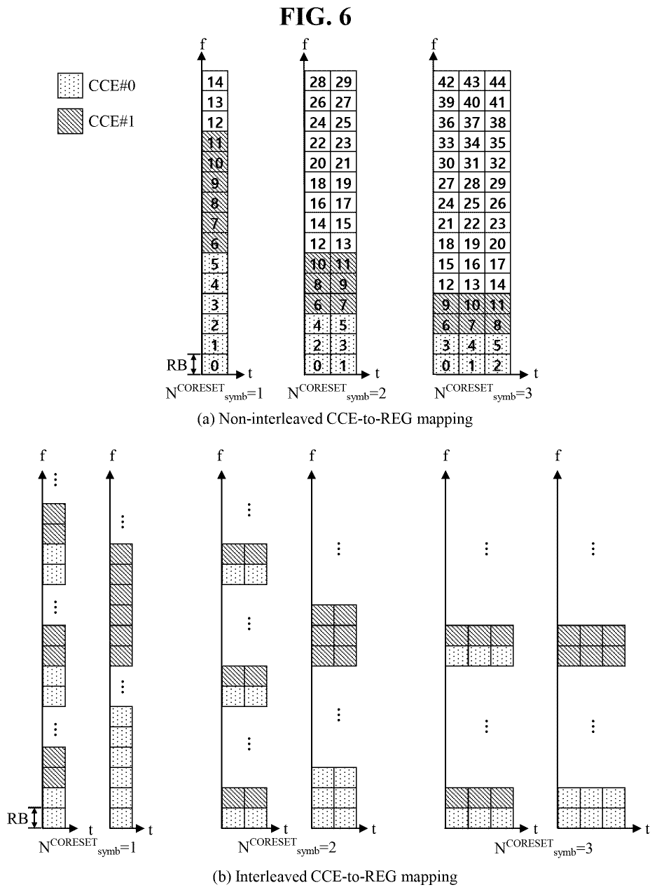

FIG. 6 illustrates mapping methods between CCEs and REGs.

The REGs and the CCEs are numbered within a CORESET. The REGs within a CORESET, which consists of N^{CORESET}_{RB} RBs in the frequency domain and N^{CORESET}_{symb} symbols in the time domain, are numbered in increasing order in a time-first manner, starting from 0 for the first OFDM symbol and the lowest-numbered RB within the CORESET. A plurality of CORESETs may be configured for a UE, and for each CORESET, the CCE-to-REG mapping may be interleaved CCE-to-REG mapping or non-interleaved CCE-to-REG mapping. In some scenarios, the CCE-to-REG mapping may be described by the following REG bundles.
A REG bundle i is defined as REGs {iL, iL+1, . . . , iL+L−1}, where L is the REG bundle size, i=0, 1, . . . , N^{CORESET}_{REG}/L−1, and N^{CORESET}_{REG}=N^{CORESET}_{REG}*N^{CORESET}_{REG} is the number of REGs in the CORESET, and
A CCE j consists of REG bundles {f(6j/L), f(6j/L+1), . . . , f(6j/L+6/L−1)}, where f(⋅) is the interleaver.

For a non-interleaved CCE-to-REG mapping, L=6 and f(x)=x. Referring to FIG. 6A, for non-interleaved CCE-to-REG mapping, six REGs are grouped to form a REG bundle for a given CCE, and all REGs within the given CCE are consecutive, and one REG bundle is the same as one CCE.

For interleaved CCE-to-REG mapping, L∈{2,6} for N^{CORESET}_{symb}=1, and L∈{N^{CORESET}_{symb}, 6} for N^{CORESET}_{symb}={2,3}. The interleaver may be defined as follows.

$$f ( x ) = ( rC + c + {n}_{shift} ) mod ( {N}_{REG}^{CORESET} / L ) \\ x = cR + r \\ r = 0 , 1 , … , R - 1 \\ c = 0 , 1 , … , C - 1 \\ C = {N}_{REC}^{CORESET} / ( LR ) \qquad [ Equation 2 ]$$

where R∈{2,3,6}. Referring to FIG. 6B, for the given CCE, two, three, or six consecutive REGs are grouped to form a REG bundle, and the REG bundles are interleaved within the CORESET. A REG bundle consists of 2 or 6 REGs for a CORESET with N^{CORESET}_{symb}=1, 2 or 6 REGs for a CORESET with N^{CORESET}_{symb}=2, and 3 or 6 REGs for a CORESET with N^{CORESET}_{symb}=3. The size of the REG bundle may be configured for each CORESET. For a CORESET configured by higher-level layer signaling (e.g., RRC signaling), N^{CORESET}_{RB} and N^{CORESET}_{symb} may be provided to the UE by the higher-level layer signaling (e.g., RRC signaling), interleaved or non-interleaved mapping may be provided to the UE by higher-level layer signaling (e.g., RRC signaling) as the CCE-to-REG mapping type, L may be provided to the UE by the higher-level layer signaling (e.g., RRC signaling) for non-interleaved mapping, and n_{shift}={0, 1, . . . , 274} is provided to the UE by the higher-level layer signaling (e.g., RRC signaling), or when not provided by the higher-level layer signaling, n_{shift}=N^{cell}_{ID}, where N^{cell}_{ID} is a cell layer cell identifier determined by a synchronization signal of the cell.

In consideration of the rapidly increasing volume of communications, methods that uses an unlicensed spectrum, that is, a shared spectrum, not licensed to a specific network operator but freely available for use by multiple network operators have been discussed. Hereinafter, 3GPP-based communication technologies applicable to uplink and/or downlink communication between UEs and BSs in the shared spectrum will be described.

Unless otherwise stated, the following definitions may be applied to terms related to the shared spectrum in the present specification.
Channel: consists of contiguous RBs on which a channel access procedure is performed in the shared spectrum and may refer to a carrier or a portion of the carrier.
Channel access procedure (CAP) refers to a procedure of assessing channel availability based on sensing to determine whether to use other communication device(s) prior to signal transmission. The BS or UE senses the channel during a sensing slot section, and when the detected power is less than an energy detection threshold value for at least a preconfigured time within the sensing slot section, the sensing slot section is considered idle or free, and otherwise, the sensing slot section is considered busy. The CAP may be referred to as listen-before-talk (LBT).
Channel occupancy refers to the transmission(s) on the channel(s) by the BS/UE after performing the CAP.
Channel occupancy time (COT) refers to the total time that the BS/UE and any BS(s)/UE(s) sharing the channel occupancy may perform transmission(s) on the channel after the BS/UE performs the CAP. The COT may be shared for transmissions between the BS and the corresponding UE(s).

Since the shared spectrum is not dedicated to a specific network operator, the BS and the UE may apply the LBT before performing the transmission on the cell configured with shared spectrum channel access. When the LBT is applied, the transmitter listens/detects the channel to determine whether the channel is free or busy and performs transmission only when the channel is considered free. That is, for the shared spectrum, a communication device needs to determine whether to use the channel of other communication device(s) before signal transmission.

In the shared spectrum, the size of the time interval and/or frequency occupancy area and/or power spectrum density (PSD) of the signal/channel transmitted by the UE may each be required to be a preconfigured level or more regarding channel occupancy. For example, the communication device may be required to perform transmission in the shared spectrum with the size of the time interval and/or frequency occupancy area, and/or the PSD of the signal/channel, which are the preconfigured level or more. In consideration of such regulations related to an occupied channel bandwidth (OCB) and PSD for the shared spectrum, a set of (evenly spaced) non-contiguous RBs in the frequency domain may be defined as a resource unit used for physical channel/signal transmission. Hereinafter, such a set of non-contiguous RBs is referred to as an interlaced RB, an RB interlace, or an interlace.

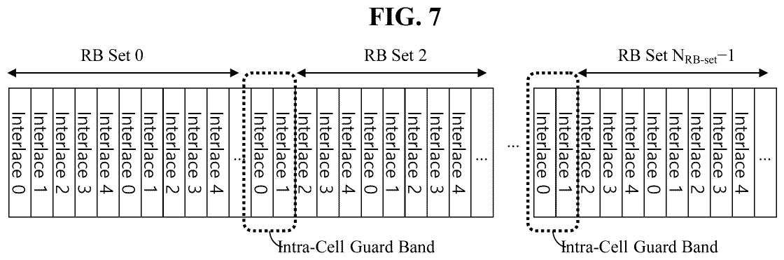

FIG. 7 illustrates an RB interlace. Referring to FIG. 7, multiple interlaces of RBs may be defined in the frequency domain. An interlace m={0, 1, . . . , M−1} may consist of (common) RBs {m, M+m, 2M+m, 3M+m, . . . }, where M represents the number of interlaced RBs. That is, each interlace may consist of multiple non-contiguous RBs. In some implementations, M may be given as follows.

TABLE 4

| u | M |
|---|---|
| 0 | 10 |
| 1 | 5 |

The interlaced RBs (n^{u}_{IRB,m}={0, 1, . . . }) and the CRB n^{u}_{CRB} within BWP i and interlace m may be given as follows. n^{u}_{CRB}=M*n^{u}_{IRB,m}+N^{start,u}_{BWP,i}+ ((m−N^{start,u}_{BWP,i}) mod M).

The communication device (e.g., a UE) may transmit a signal/channel using one or more interlaced RBs.

For example, in a 3GPP-based system, resource block assignment information (RB) in the DCI carried by the PDCCH informs the UE of a set of up to M interlace indices and a set of up to N^{BWP}_{RB-set} UL contiguous RB sets (for DCI format 0_0 and DCI format 0_1 monitored in a UE-specific search space). The set of RBs consists of multiple contiguous RBs. DCI format 0_0 and DCI format 0_1 are the DCI formats used to schedule the PUSCH. In some implementations, the set of RBs may correspond to a frequency resource on which the CAP is performed individually in the shared spectrum. For the operation with shared spectrum channel access, uplink transmission subcarriers are mapped to one or more RB interlaces.

In some scenarios, the UE may determine that RB(s) corresponding to the intersection of i) the indicated interlace, ii) the indicated RB set(s), and (if any) the union of the guard bands between the indicated RB set(s) are the frequency resource for PUSCH transmission.

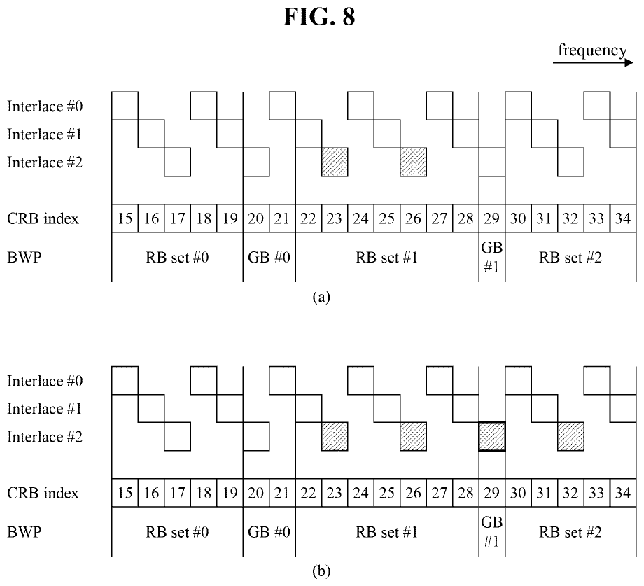

FIG. 8 illustrates interlaced RB-based uplink resource allocation in a shared spectrum. FIG. 8A illustrates a case in which one RB set is indicated through resource allocation information for PUSCH, and FIG. 8B illustrates a case in which contiguous RB sets are indicated through the resource allocation information for PUSCH.

Referring to FIG. 8A, based on resource allocation (RA) information for PUSCH indicating {Interlace #2, RB Set #1}, it may be determined that RBs belonging to Interlace #2 in RB Set #1 are PUSCH resources. That is, it may be determined that RBs corresponding to the intersection of {Interlace #2, RB Set #1} are PUSCH resources. Referring to FIG. 8B, based on the resource allocation information for PUSCH indicating {Interlace #2, RB Sets #1/#2}, it may be determined that RBs belonging to Interlace #2 in RB Sets #1 and #2 are PUSCH resources. In this case, the guard band (i.e., GB #1) between RB Set #1 and RB Set #2 may also be used as a PUSCH transmission resource. That is, in some implementations, it may be determined that RBs corresponding to the intersection of {Interlace #2, RB Set #1+RB Set #2+GB #1} are PUSCH resources. In this case, the guard band (i.e., GB #0), which is adjacent to RB Sets #1 and #2 but not present between RB Set #1 and RB Set #2, is not used as a PUSCH transmission resource.

Multiple RB sets may be configured for the operation of the shared spectrum, with each RB set corresponding to about 20 MHz. In addition, interlacing may be configured for the operation of the shared spectrum. For example, an RB set with a 15 kHz subcarrier spacing may include 10 interlaces, each of which corresponds to 10 RBs. As another example, an RB set with a 30 kHz subcarrier spacing may include 5 interlaces, each of which corresponds to 10 RBs. Guard bands are configured between adjacent RB sets, thereby preventing some RBs in the shared spectrum from being used for transmission. Interlaced RB-based transmission has been applied to uplink transmission so far. However, since an increase in the number of UEs participating in communication leads to an increase in both uplink and downlink transmission, it is preferable to allow the interlaced RB-based transmission for downlink control/data transmission. When the interlaced RB-based transmission is applied to downlink, in particular when the interlaced RB-based transmission is applied to PDCCH transmission, the PDCCH structure (hereinafter referred to as a REG-based PDCCH) described in FIGS. 5 and 6 cannot be easily applied. This is because, according to the PDCCH structure described in FIGS. 5 and 6, each CCE consists of six RBs, making it difficult to align with the number of RBs per interlace. In addition, in the case of the interleaved PDCCH structure, an interleaving space is not aligned with the interlace. In addition, since some RBs cannot be used on the shared spectrum, when a CORESET is configured on the shared spectrum, some CCEs within the CORESET may not be available for PDCCH transmission.

As the types of services that wireless communication systems need to support diversify and traffic increases rapidly, the utilization of shared spectrum is becoming increasingly important. There is a need for a method for efficiently transmitting PDCCHs on a shared spectrum that supports interlaced transmission. Hereinafter, some implementations of the present specification regarding the PDCCH structure will be described.

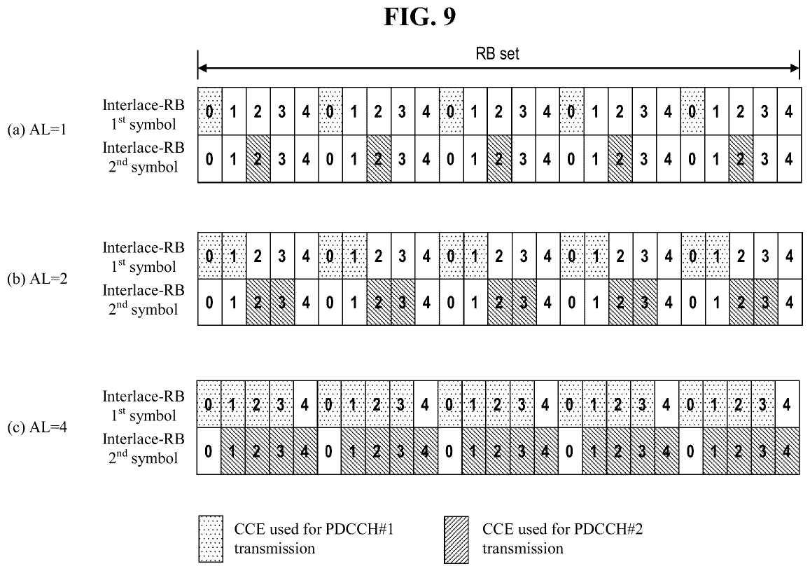

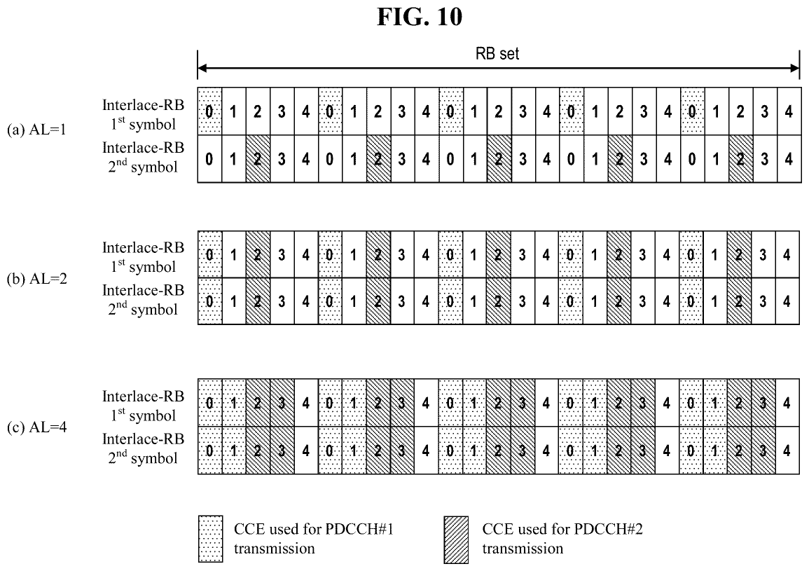

FIGS. 9 and 10 illustrate the basic concept of an interlace-based PDCCH structure according to some implementations of the present specification.

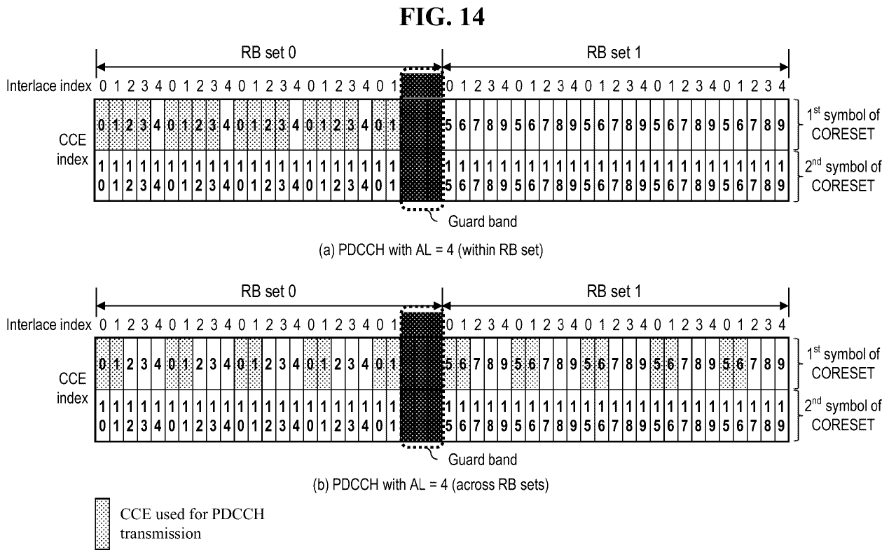

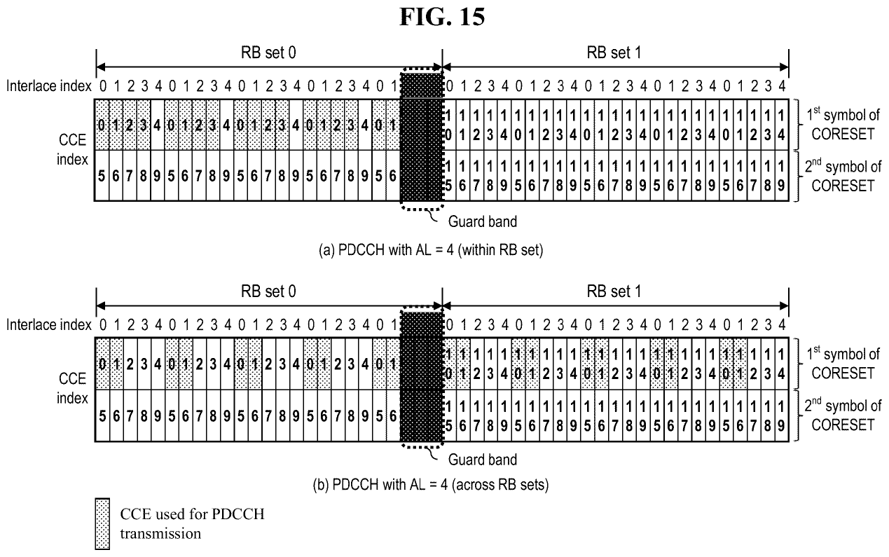

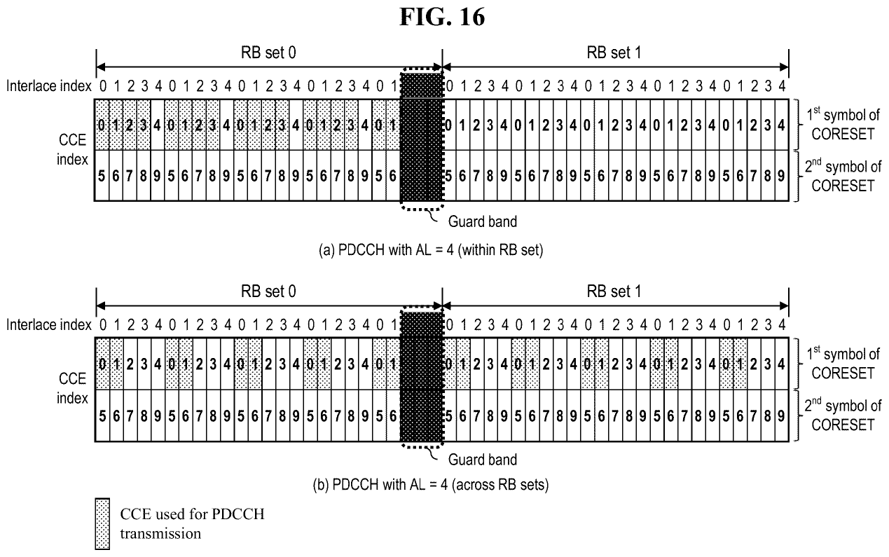

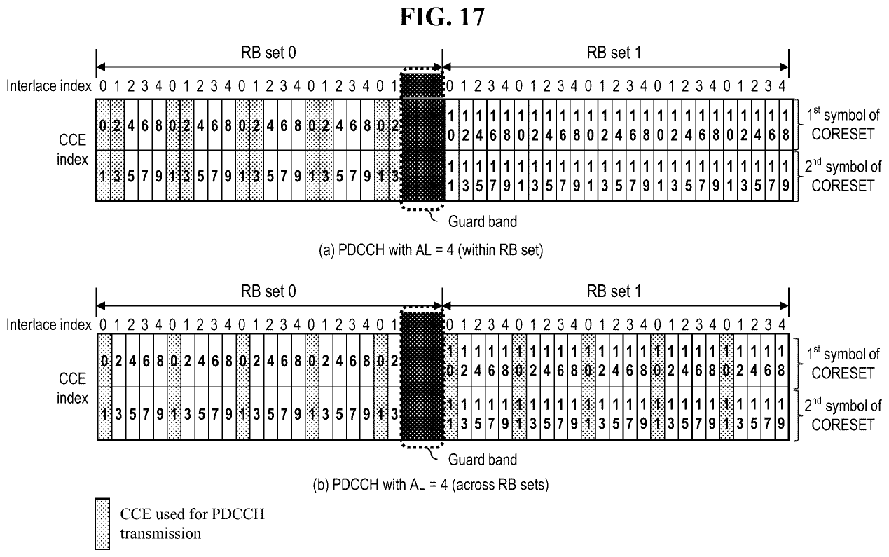

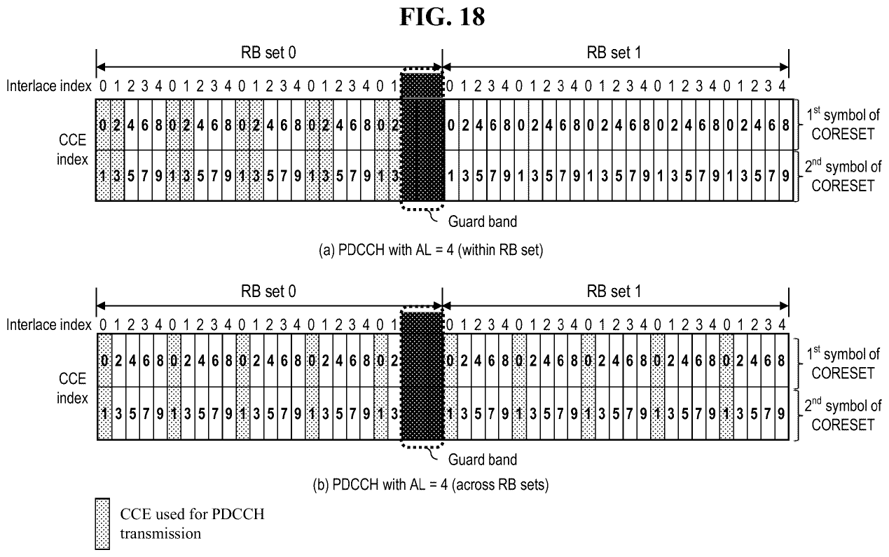

In some implementations of the present specification, for a cell or BWP configured for interlaced RB-based transmission (or interlaced RB-based resource allocation), or for a cell or BWP within a shared spectrum, the PDCCH structure may be defined/configured as follows.
A CORESET consists of NCORESETR (>=1) RB sets in the frequency domain, and one CCE consists of one interlace (including a DM-RS) within an OFDM symbol within the RB set. The CORESET may consist of N^{CORESET}_{symb} OFDM symbols in the time domain, as in the non-shared spectrum. N^{CORESET}_{RB-set} and N^{CORESET}_{symb} may be predefined or configured by the BS to the UE through the higher-level layer signaling (RRC signaling). In some implementations, it may be further considered that one CCE consists of 0.5 interlaces.—In some implementations, CCEs in a CORESET may be numbered in a frequency-first manner (hereinafter referred to as frequency-first CCE indexing or frequency-first CCE numbering). For example, frequency-first interlace-to-CCE mapping may be applied. FIG. 9 illustrates examples of PDCCH transmissions according to aggregation levels AL in a situation in which CCEs are numbered in a frequency-first manner. Referring to FIG. 9B, a single PDCCH (e.g., PDCCH #1) may be transmitted using the CCEs of interlace #0 and interlace #1 within an RB set during a 1^{st} OFDM symbol of the CORESET. Likewise, PDCCH #2 may be transmitted using CCEs of interlace #2 and interlace #3 within an RB set during a 2nd OFDM symbol of the CORESET. Consequently, PDCCH #1 and PDCCH #2 may each be transmitted in a different OFDM symbol. In some implementations, when the CORESET consists of a plurality of RB sets in the frequency domain, the frequency-first CCE indexing may be performed across the plurality of RB sets (e.g., see the CCE indices in FIG. 14). In this case, different CCE indices are allocated to CCEs on different RB sets. Alternatively, the frequency-first indexing may be performed on each RB set. For example, CCE indices may be allocated to CCEs within the CORESET in such a manner that the frequency-first CCE indexing is performed during N^{CORESET}_{symb} OFDM symbol(s) within an RB set, starting from the RB set of the lowest index, and then the frequency-first CCE indexing is performed on the start CCE of the next RB set, starting from the CCE index following the greatest CCE index allocated to that RB set (e.g., see CCE indices in FIG. 15). Alternatively, in some implementations, the frequency-first CCE indexing may be performed in such a manner that the CCE index is initialized for each RB set (e.g., see CCE indices in FIG. 16). In this case, CCEs belonging to different RB sets may have the same CCE index. When the frequency-indexing is reset for each RB set, the CCEs belonging to different RB sets are considered different CCEs even when they have the same CCE index.
In some implementations, CCEs in a CORESET may be numbered in a time-first manner (hereinafter referred to as time-first CCE indexing or time-first CCE numbering). For example, time-first interlace-to-CCE mapping may be applied. FIG. 10 illustrates an example of PDCCH transmission according to AL in a situation in which CCEs are numbered in a time-first manner. For example, in the case of AL=2 and time-first CCE mapping, referring to FIG. 10B, in a CORESET with N^{CORESET}_{symb}=2, each PDCCH may be transmitted using both the 1^{st} OFDM symbol and the 2^{nd} OFDM symbol. In some implementations, when the CORESET consists of a plurality of RB sets in the frequency domain, the time-first CCE indexing may be performed across the plurality of RB sets (e.g., see the CCE indices in FIG. 17). In this case, different CCE indices are allocated to CCEs on different RB sets. Alternatively, in some implementations, the time-first indexing may be performed in such a manner that the CCE index is initialized for each RB set. In this case, CCEs belonging to different RB sets may have the same CCE index (e.g., see the CCE indices in FIG. 18). When the frequency-indexing is reset for each RB set, the CCEs belonging to different RB sets are considered different CCEs even when they have the same CCE index.
In some implementations, an aggregation level L may be defined as an L interlace. For example, for the aggregation level L, one PDCCH may be transmitted across L interlaces. When one CCE is defined as being equal to one interlace within an OFDM symbol, a PDCCH at an aggregation level L may be represented as consisting of L CCEs, as illustrated in FIGS. 9 and 10.
Alternatively, in some implementations, the aggregation level L may be defined as K*L interlaces, where K is the number of interlaces per CCE.
The number of PDCCH candidates per search space may be configured.
Partial CCEs may be used for high aggregation levels.

In some implementations of the present specification, when a CORESET is defined/configured on an interlace basis, the PDCCH may be transmitted on an interlace basis, thereby improving resource utilization efficiency.

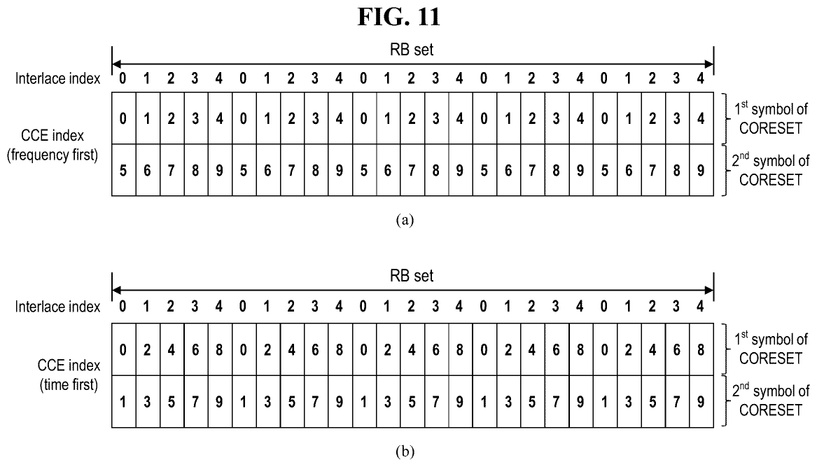

FIG. 11 illustrates examples of interlace-to-CCE mapping for interlace-based PDCCH according to some implementations of the present specification. The examples in FIG. 11 assume a CORESET with NCORESETRB-set=1 and N^{CORESET}_{symb}=2.

Referring to FIG. 11A, in some implementations, frequency-first interlace-to-CCE mapping may be applied for the interlace-based PDCCH. When the interlace-to-CCE mapping is performed in a frequency-first manner, the PDCCH is more likely to be transmitted on consecutive interlaces within a single symbol, and thus the UE may perform an early termination operation during PDCCH blind decoding, thereby achieving UE power savings.

Referring to FIG. 11B, in some implementations, time-first interlace-to-CCE mapping may be applied for the interlace-based PDCCH. When the interlace-to-CCE mapping is performed in a time-first manner, the PDCCH is more likely to be transmitted across multiple symbols of a CORESET, thereby improving PDCCH reception quality.

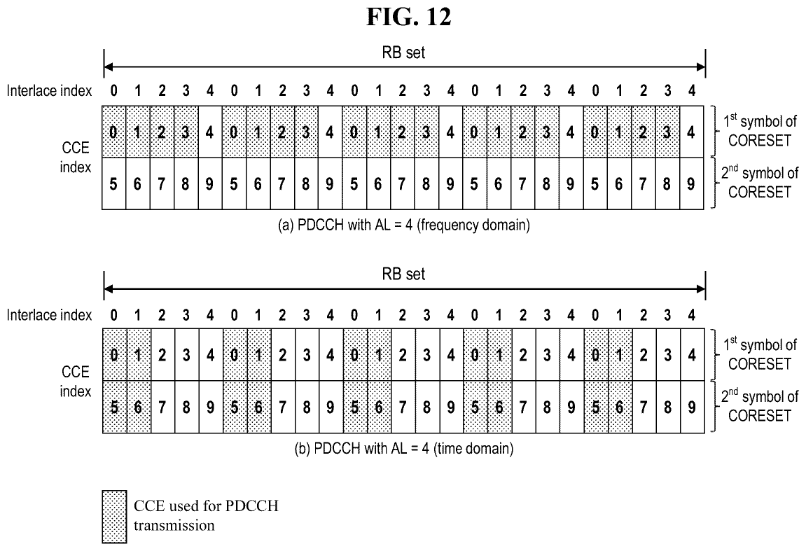

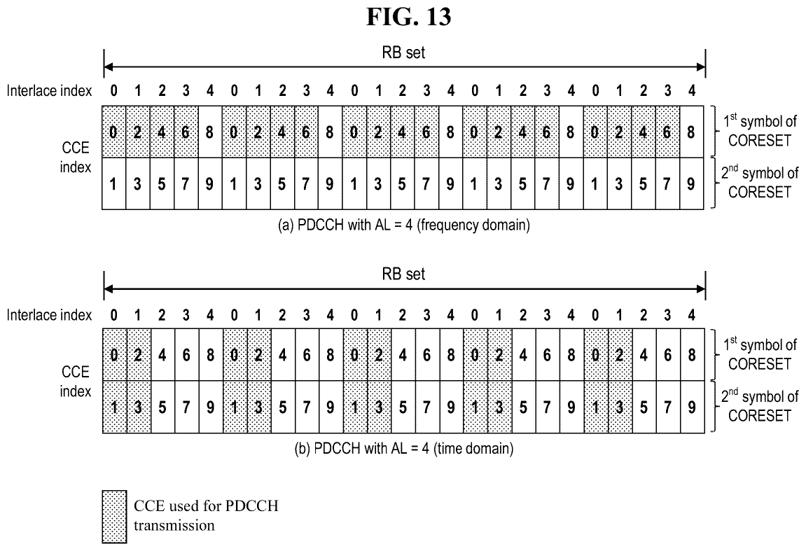

FIGS. 12 and 13 illustrate examples of CCE aggregation according to some implementations of the present specification.

The example in FIG. 12A assumes frequency-first interlace-to-CCE mapping and mapping of the PDCCH to contiguous or consecutive CCEs. Referring to FIG. 12A, in some implementations, CCEs may be aggregated first in the frequency domain. For example, when AL=4, the PDCCH may consist of four consecutive CCEs in the frequency domain (CCE #0 to CCE #3 in FIG. 12A). As another example, when AL=8, the PDCCH may consist of eight consecutive CCEs (CCE #0 to CCE #7 in FIG. 12A).

The example of FIG. 12B assumes time-first interlace-to-CCE mapping and mapping of the PDCCH to non-contiguous or non-consecutive CCEs. Referring to FIG. 12B, in some implementations, CCEs may be aggregated first in the time domain. For example, when AL=4, in a CORESET with N^{CORESET}_{symb}=2, four CCEs (CCE #0, CCE #1, CCE #5, and CCE #6 in FIG. 12B) consisting of two consecutive interlaces in the frequency domain and two OFDM symbols in the time domain may be used for PDCCH transmission. As another example, when AL=8, in a CORESET with N^{CORESET}_{symb}=2, eight CCEs (CCE #0, CCE #5, CCE #1, CCE #6, CCE #2, CCE #7, CCE #3, and CCE #8 in FIG. 12B) consisting of four consecutive interlaces in the frequency domain and two OFDM symbols in the time domain may be used for PDCCH transmission.

The example of FIG. 13A assumes time-first interlace-to-CCE mapping and mapping of the PDCCH to non-contiguous or non-consecutive CCEs. Referring to FIG. 13A, in some implementations, CCEs may be aggregated first in the frequency domain. For example, when AL=4, the PDCCH may consist of four consecutive CCEs in the frequency domain (CCE #0, CCE #2, CCE #4, and CCE #6 in FIG. 13A). As another example, when AL=8, the PDCCH may consist of eight CCEs (CCE #0, CCE #2, CCE #4, CCE #6, CCE #8, CCE #1, CCE #3, and CCE #5 in FIG. 13A).

The example in FIG. 13A assumes time-first interlace-to-CCE mapping and mapping of the PDCCH to contiguous or consecutive CCEs. Referring to FIG. 13B, in some implementations, CCEs may be aggregated first in the time domain. For example, when AL=4, in a CORESET with N^{CORESET}_{symb}, four CCEs (CCE #0 to CCE #3 in FIG. 13B) consisting of two consecutive interlaces in the frequency domain and two OFDM symbols in the time domain may be used for PDCCH transmission. As another example, when AL=8, in a CORESET with N^{CORESET}_{symb}=2, eight CCEs (CCE #0 to CCE #7 in FIG. 12B) consisting of four consecutive interlaces in the frequency domain and two OFDM symbols in the time domain may be used for PDCCH transmission.

In some implementations of the present specification, the frequency-first PDCCH-to-CCE mapping (FIG. 12A or 13A) and the time-first PDCCH-to-CCE mapping (FIG. 12B or 13B) may be used interchangeably. For example, when ALL, L CCEs within a CORESET may be selected and mapped to the PDCCH based on a (pre-) configured or (pre-) defined pattern. Alternatively, in some implementations of the present specification, the frequency-first PDCCH-to-CCE mapping may be applied for the frequency-first interlace-to-CCE mapping, and the time-first PDCCH-to-CCE mapping may be applied for the time-first interlace-to-CCE mapping.

In some implementations of the present specification, the interlace-to-CCE mapping method applied to a cell or BWP configured for interlaced RB-based transmission (or interlaced RB-based resource allocation) or to a cell or BWP within a shared spectrum may be predefined between the BS and the UE. Alternatively, in some implementations of the present specification, the interlace-to-CCE mapping method applied to a cell or BWP configured for interlaced RB-based transmission (or interlaced RB-based resource allocation) or to a cell or BWP within a shared spectrum may be provided by the BS to the UE via a PBCH on the cell or the like. A guard band may be configured between RB sets on the shared spectrum. Since interference between transmissions occurring on RB sets may be present within the guard band, it is not recommended for use for control channel transmission. Due to guard bands between RB sets, partial interlace(s) in which the number of RBs contained in an interlace is less than the number of RBs contained in other interlaces may be present. In some implementations of the present specification, the partial interlaces may be handled as follows.
Alt1. The partial interlace is excluded from a CCE count. That is, the partial interlace is not used for PDCCH transmission. In this case, the partial interlace may not be allocated a CCE index. Since the partial interlace is not treated as a CCE according to Alt 1, when the partial CCE is not used for PDCCH transmission, the PDCCH reception quality at the UE can be maintained consistently.
Alt2. The partial interlace is included in a CCE count. That is, the partial interlace may also be used for PDCCH transmission. In this case, the partial interlace may also be allocated a CCE index. According to Alt 2, partial interlaces are treated as CCEs, and when partial CCEs are used for PDCCH transmission, the amount of unavailable resources in the frequency domain is reduced, thereby enhancing resource efficiency.
Alt3. Partial interlaces may be used for PDCCH transmission only for higher aggregation levels (e.g., AL>4). This is because, for higher aggregation levels, even when partial CCEs are used for PDCCH transmission, PDCCH reception quality can be improved by other full CCEs, and thus the degradation of PDCCH reception quality due to partial CCEs can be less than at lower aggregation levels.

FIGS. 14 to 18 illustrate examples of transmitting a PDCCH across multiple RB sets according to some implementations of the present specification. In the examples of FIGS. 14 to 18, it is assumed that CORESET is configured across RB sets 0 and RB sets 1 in the frequency domain and one CCE is equal to one interlace during an OFDM symbol within an RB set. The examples of FIG. 14 assume frequency-first CCE indexing across RB sets. The examples of FIG. 15 assume frequency-first CCE indexing for each RB set. The examples of FIG. 16 assume frequency-first CCE indexing that initializes the CCE index per RB set, that is, starts with the same CCE index for each RB set. For the frequency-first CCE indexing that initializes the CCE index per RB set, CCEs with the same CCE index belonging to different RB sets are treated as different CCEs. The examples of FIG. 17 assume time-first CCE indexing across RB sets. The examples of FIG. 18 assume time-first CCE indexing, which initializes the CCE index for each RB set.

A plurality of RB sets may be configured for the operation of the shared spectrum, and guard bands may be configured between adjacent RB sets. Hereinafter, implementations of the present specification in which PDCCHs are mapped when a plurality of RB sets are configured within a shared spectrum or within a single BWP will be described.

Referring to FIGS. 14A, 15A, 16A, 17A, and 18A, in some implementations of the present specification, PDCCH candidates are mapped within RB sets. Referring to FIGS. 14A, 15A, 17A, and 18A, for AL=4, a PDCCH candidate may consist of, for example, four CCEs, CCE #0 to CCE #3, within RB set 0. When PDCCH candidates are mapped within the RB set, a PDCCH transmission bandwidth does not exceed a bandwidth of the RB set, thereby reducing the power consumption of the UE during PDCCH monitoring. In some implementations, the search space can be defined per RB set. Alternatively, in some implementations, the search space may be defined over a plurality of RB sets.

Referring to FIGS. 14B, 15B, 16B, 17B, and 18B, in some implementations of the present specification, PDCCH candidates are mapped across RB sets. Referring to FIG. 14B, for AL=4, a PDCCH candidate may consist of four CCEs, for example, CCE #0 and CCE #1 in RB set 0, and CCE #5 and CCE #6 in RB set 1. Referring to FIG. 15B, for AL=4, a PDCCH candidate may consist of four CCEs, for example, CCE #0 and CCE #1 in RB set 0, and CCE #10 and CCE #11 in RB set 1. Referring to FIG. 16B, for AL=4, a PDCCH candidate may consist of four CCEs, for example, CCE #0 and CCE #1 in RB set 0, and CCE #0 and CCE #1 in RB set 1. Referring to FIG. 17B, for AL=4, a PDCCH candidate may consist of four CCEs, for example, CCE #0 and CCE #1 in RB set 0, and CCE #5 and CCE #15 in RB set 1. Referring to FIG. 18B, for AL=4, a PDCCH candidate may consist of four CCEs, for example, CCE #0 and CCE #1 in RB set 0, and CCE #0 and CCE #1 in RB set 1. When PDCCH candidates are mapped across RB sets, frequency diversity gains may be obtained. In some implementations, mapping PDCCH candidates across a plurality of RB sets may be supported under the condition of higher aggregation levels (e.g., AL>8).

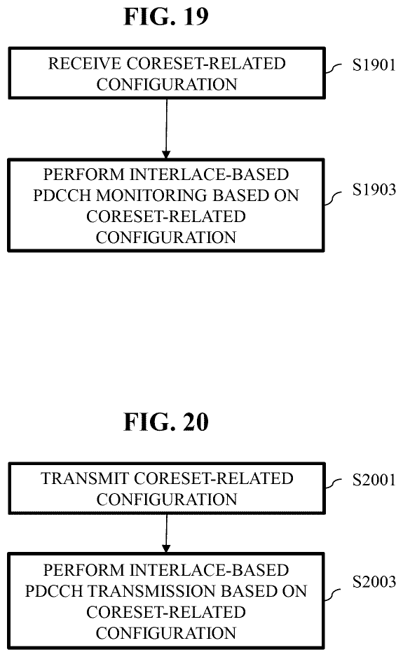

FIG. 19 illustrates a portion of a process by which a user equipment (UE) receives a downlink channel according to some implementations of the present specification.

The UE may receive a configuration related to a CORESET to which an interlace-based PDCCH structure is applied (S1901). The CORESET-related configuration may include information about RB set(s) in a frequency domain that constitute the CORESET and information about the number of OFDM symbols in the time domain, according to some implementations of the present specification.

The UE may monitor the PDCCH on an interlace basis according to the CORESET-related configuration (S1903). For example, the UE may perform PDCCH monitoring assuming that each PDCCH candidate within the search space associated with the CORESET is configured on an interlace basis according to some implementations of the present specification described above.

When detecting a DCI format through PDCCH monitoring, the UE may perform operations according to the DCI format.

FIG. 20 illustrates a portion of a process by which a BS transmits a downlink channel according to some implementations of the present specification.

The BS may transmit a configuration related to a CORESET to which an interlace-based PDCCH structure is applied (S2001). The CORESET-related configuration may be an RRC configuration provided by the BS to the UE. The CORESET-related configuration may include information about RB sets in a frequency domain that constitute the CORESET and information about the number of OFDM symbols in the time domain, according to some implementations of the present specification.

The BS may perform interlace-based PDCCH transmission according to the CORESET-related configuration (S2003). The BS may transmit a PDCCH carrying a DCI format within a search space associated with the CORESET according to the CORESET-related configuration. PDCCH monitoring may be performed assuming that each PDCCH candidate monitored by the UE is configured on an interlace basis according to some implementations of the present specification described above.

The BS may perform downlink transmission(s) and/or uplink reception(s) assuming that the UE detecting the DCI format will perform operations according to the DCI format.

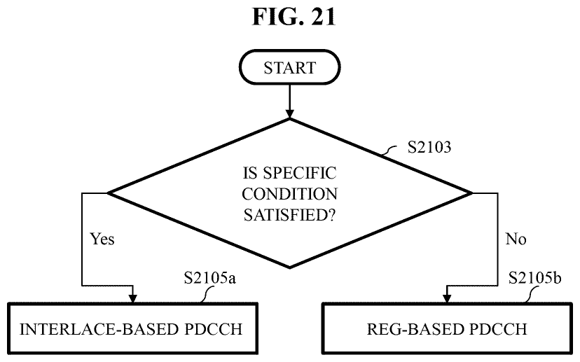

FIG. 21 illustrates a PDCCH transmission/monitoring flow according to some implementations of the present specification.

Interlace-based PDCCH according to some implementations of the present specification described above may be applied under specific conditions. The specific conditions may include, for example, the following:
PDCCH transmission or PDCCH monitoring is performed in a shared spectrum,
PDCCH transmission or PDCCH monitoring is performed in a cell or BWP in which interlace-RB-based transmission is configured,
PDCCH transmission or PDCCH monitoring is performed in a cell or BWP configured for the UE to use interlace-RB-based frequency-domain resource allocation for PUSCH or PDSCH, and/or
PDCCH transmission or PDCCH monitoring is performed in a search space associated with a CORESET configured with interlace-based transmission.

In some implementations, information about whether a cell or BWP in which PDCCH transmission or PDCCH monitoring is performed belongs to a shared spectrum may be provided to UEs via a PBCH within a synchronization signal block (SSB) transmitted over the cell or BWP.

In some implementations, the interlace-RB-based transmission for the cell or BWP in which PDCCH transmission or PDCCH monitoring is performed may be provided to the UE through RRC signaling. In some implementations, the interlace-RB-based frequency domain resource allocation for PUSCH or PDSCH may be provided to the UE through RRC signaling for the cell or BWP in which PDCCH transmission or PDCCH monitoring is performed.

In some implementations, an RRC configuration for a CORESET may include a configuration regarding whether the CORESET is interlace-based.

In some implementations of the present specification, when the above specific condition is satisfied (Yes in S2103), the interlace-based PDCCH according to some implementations of the present specification may be applied to PDCCH transmission or PDCCH monitoring (S2105a), and otherwise (No in S2103), the REG-based PDCCH described in FIG. 5 or FIG. 6 may be applied to PDCCH transmission or PDCCH monitoring (S2105b).

A UE may perform operations according to some implementations of the present specification in relation to the PDCCH reception. The UE may include at least one transceiver, at least one processor, and at least one computer memory that is operably connected to the at least one processor and stores instructions that, when executed, cause the at least one processor to perform operations according to some implementations of the present specification. A processing device for the UE may include at least one processor, and at least one computer memory that is operably connected to the at least one processor and stores instructions that, when executed, cause the at least one processor to perform operations according to some implementations of the present specification. A computer-readable (non-transitory) storage medium may store at least one computer program including instructions that, when executed by the at least one processor, cause the at least one processor to perform operations according to some implementations of the present specification. A computer program or computer program product may be recorded on at least one computer-readable (non-transitory) storage medium and may include instructions that, when executed, cause (at least one processor) to perform operations according to some implementations of the present specification.

A BS may perform operations according to some implementations of the present specification in relation to the PDCCH transmission. The BS may include at least one transceiver, at least one processor, and at least one computer memory that is operably connected to the at least one processor and stores instructions that, when executed, cause the at least one processor to perform operations according to some implementations of the present specification. A processing device for the BS may include at least one processor, and at least one computer memory that is operably connected to the at least one processor and stores instructions that, when executed, cause the at least one processor to perform operations according to some implementations of the present specification. A computer-readable (non-transitory) storage medium may store at least one computer program including instructions that, when executed by the at least one processor, cause the at least one processor to perform operations according to some implementations of the present specification. A computer program or computer program product may be recorded on at least one computer-readable (non-transitory) storage medium and may include instructions that, when executed, cause (at least one processor) to perform operations according to some implementations of the present specification.

In the UE, the processing device, the computer-readable (non-transitory) storage medium, and/or the computer program product, the operations may include receiving a configuration regarding a CORESET, monitoring a set of PDCCH candidates based on the configuration, and detecting a DCI format within the set of PDCCH candidates. In the BS, the processing device, the computer-readable (non-transitory) storage medium, and/or the computer program product, the operations may include transmitting a configuration regarding a CORESET, and transmitting a DCI format within the set of PDCCH candidates based on the configuration.

In some implementations, the CORESET may consist of N^{CORESET}_{RB-set} RB sets, each of which includes a plurality of contiguous RBs in the frequency domain, and N^{CORESET}_{symb} OFDM symbols in the time domain. In some implementations, each PDCCH candidate within the CORESET may consist of one or more CCEs. In some implementations, each CCE within the CORESET may be equal to one interlace during an OFDM symbol within an RB set for the CORESET.

In some implementations, each of the one or more interlaces may consist of a plurality of non-contiguous RBs.

In some implementations, the CCEs within the CORESET may be numbered in increasing order in a frequency-first manner, starting from 0 for the first OFDM symbol and the lowest-numbered interlace within the CORESET.

In some implementations, the CCEs within the CORESET may be numbered in increasing order in a time-first manner, starting from 0 for the first OFDM symbol and the lowest-numbered interlace within the CORESET.

In some implementations, the configuration may include the number of PDCCH candidates for each aggregation level L. Each PDCCH candidate at the aggregation level L may include L CCEs within the COREST.

In some implementations, each PDCCH candidate within the CORESET may consist of CCEs from one RB set.

In some implementations, each PDCCH candidate within the CORESET may consist of CCEs from a plurality of RB sets.

In some implementations, two adjacent RB sets among the N^{CORESET}_{RB-set} RB sets within the CORESET may have a guard band between the two adjacent RB sets.

In some implementations, each CCE within the CORESET may not be mapped to an interlace in which some of the RBs are included in the guard band.

In some implementations, the CORESET may include a CCE mapped to an interlace in which some RBs are included in the guard band.

As described above, the examples disclosed in the present specification are provided to enable those skilled in the art to implement and practice the present specification. While the above description has been provided with reference to the examples of the present specification, those skilled in the art can modify and change the examples of the present specification in various ways. Accordingly, the present specification is not intended to be limited to the examples described herein but is intended to provide the broadest scope consistent with the principles and novel features disclosed herein.

The implementations of the present specification may be used in wireless communication systems, including a BS, user equipment, and other devices.

1. A method for receiving, by a user equipment, a downlink channel in a wireless communication system, the method comprising:
receiving a configuration for a control resource set (CORESET);
monitoring a set of physical downlink control channel (PDCCH) candidates based on the configuration; and
detecting a downlink control information (DCI) format within the set of PDCCH candidates,
wherein, the CORESET consists of N^{CORESET}_{RB-set} resource blocks (RBs), each of which includes a plurality of contiguous RBs in a frequency domain, and N^{CORESET}_{symb} orthogonal frequency division multiplexing (OFDM) symbols in a time domain,
each PDCCH candidate within the CORESET consists of one or more control channel elements (CCEs), and
each CCE within the CORESET is equal to one interlace during an OFDM symbol within an RB set for the CORESET.

2. The method of claim 1, wherein each of the one or more interlaces consists of a plurality of non-contiguous RBs.

3. The method of claim 1, wherein the CCEs within the CORESET are numbered in increasing order in a frequency-first manner, starting from 0 for a first OFDM symbol and a lowest-numbered interlace within the CORESET.

4. The method of claim 1, wherein the CCEs within the CORESET are numbered in increasing order in a frequency-first manner, starting from 0 for a first OFDM symbol and a lowest-numbered interlace within the CORESET.

5. The method of claim 1, wherein the configuration includes the number of PDCCH candidates for each aggregation level (L), and
each PDCCH candidate at the aggregation level (L) includes L CCEs within the COREST.

6. The method of claim 1, wherein each PDCCH candidate within the CORESET consists of CCEs from one RB set.

7. The method of claim 1, wherein each PDCCH candidate within the CORESET consists of CCEs from a plurality of RB sets.

8. The method of claim 1, wherein two adjacent RB sets among the N^{CORESET}_{RB-set} RB sets within the CORESET have a guard band between the two adjacent RB sets, and
each CCE within the CORESET is not mapped to an interlace in which some RBs are included in the guard band.

9. The method of claim 1, wherein two adjacent RB sets among the N^{CORESET}_{RB-set} RB sets within the CORESET have a guard band between the two adjacent RB sets, and
the CORESET includes a CCE mapped to an interlace in which some RBs are included in the guard band.

10. A user equipment for receiving a downlink channel in a wireless communication system, comprising:
at least one transceiver;
at least one processor; and
at least one memory that is operatively connected to the at least one processor and stores instructions that, when executed, cause the at least one processor to perform operations,
wherein the operations includes:
receiving a configuration for a control resource set (CORESET);
monitoring a set of physical downlink control channel (PDCCH) candidates based on the configuration; and
detecting a downlink control information (DCI) format within the set of PDCCH candidates,
wherein, the CORESET consists of N^{CORESET}_{RB-set} resource blocks (RBs), each of which includes a plurality of contiguous RBs in a frequency domain, and N^{CORESET}_{symb} orthogonal frequency division multiplexing (OFDM) symbols in a time domain,
each PDCCH candidate within the CORESET consists of one or more control channel elements (CCEs), and
each CCE within the CORESET is equal to one interlace during an OFDM symbol within an RB set for the CORESET.

11. A computer-readable non-transitory storage medium including at least one computer program that causes at least one processor to perform operations, wherein the operations includes:
receiving a configuration for a control resource set (CORESET);
monitoring a set of physical downlink control channel (PDCCH) candidates based on the configuration; and
detecting a downlink control information (DCI) format within the set of PDCCH candidates,
wherein, the CORESET consists of N^{CORESET}_{RB-set} resource blocks (RBs), each of which includes a plurality of contiguous RBs in a frequency domain, and N^{CORESET}_{symb} orthogonal frequency division multiplexing (OFDM) symbols in a time domain,
each PDCCH candidate within the CORESET consists of one or more control channel elements (CCEs), and
each CCE within the CORESET is equal to one interlace during an OFDM symbol within an RB set for the CORESET.

12. A method for transmitting, by a base station, a downlink channel in a wireless communication system, the method comprising:
transmitting a configuration for a control resource set (CORESET); and
based on the configuration, transmitting a downlink control information (DCI) format within a set of physical downlink control channel (PDCCH) candidates,
wherein, the CORESET consists of N^{CORESET}_{RB-set} resource blocks (RBs), each of which includes a plurality of contiguous RBs in a frequency domain, and N^{CORESET}_{symb} orthogonal frequency division multiplexing (OFDM) symbols in a time domain,
each PDCCH candidate within the CORESET consists of one or more control channel elements (CCEs), and
each CCE within the CORESET is equal to one interlace during an OFDM symbol within an RB set for the CORESET.

13. The method of claim 12, wherein each of the one or more interlaces consists of a plurality of non-contiguous RBs.

14. The method of claim 12, wherein the CCEs within the CORESET are numbered in increasing order in a frequency-first manner, starting from 0 for a first OFDM symbol and a lowest-numbered interlace within the CORESET.

15. The method of claim 12, wherein the CCEs within the CORESET are numbered in increasing order in a frequency-first manner, starting from 0 for a first OFDM symbol and a lowest-numbered interlace within the CORESET.

16. The method of claim 12, wherein the configuration includes the number of PDCCH candidates for each aggregation level (L), and
each PDCCH candidate at the aggregation level (L) includes L CCEs within the COREST.

17. The method of claim 12, wherein each PDCCH candidate within the CORESET consists of CCEs from one RB set.

18. The method of claim 12, wherein each PDCCH candidate within the CORESET consists of CCEs from a plurality of RB sets.

19. The method of claim 12, wherein two adjacent RB sets among the N^{CORESET}_{RB-set} RB sets within the CORESET have a guard band between the two adjacent RB sets, and
each CCE within the CORESET is not mapped to an interlace in which some RBs are included in the guard band.

20. The method of claim 12, wherein two adjacent RB sets among the N^{CORESET}_{RB-set} RB sets within the CORESET have a guard band between the two adjacent RB sets, and
the CORESET includes a CCE mapped to an interlace in which some RBs are included in the guard band.

21. A base station for transmitting a downlink channel in a wireless communication system, comprising:
at least one transceiver;
at least one processor; and
at least one memory that is operatively connected to the at least one processor and stores instructions that, when executed, cause the at least one processor to perform operations,
wherein the operations includes:
transmitting a configuration for a control resource set (CORESET); and
based on the configuration, transmitting a downlink control information (DCI) format within a set of physical downlink control channel (PDCCH) candidates,
wherein, the CORESET consists of N^{CORESET}_{RB-set} resource blocks (RBs), each of which includes a plurality of contiguous RBs in a frequency domain, and N^{CORESET}_{symb} orthogonal frequency division multiplexing (OFDM) symbols in a time domain,
each PDCCH candidate within the CORESET consists of one or more control channel elements (CCEs), and
each CCE within the CORESET is equal to one interlace during an OFDM symbol within an RB set for the CORESET.
